(19) United States
(12) Patent Application Publication
(10) Pub. No.: US 2023/0180780 A1
(43) Pub. Date: Jun. 15, 2023

(54) ANIMAL FAT SUBSTITUTE

(71) Applicant: 77 FOODS, Saint-Ouen (FR)

(72) Inventors: Vincent POULICHET, Paris (FR); Tamas PRILESZKY, Paris (FR)

(21) Appl. No.: 17/924,953

(22) PCT Filed: May 12, 2021
(86) PCT No.: PCT/EP2021/062769

§ 371 Date: Nov. 11, 2022

(30) Foreign Application Priority Data
May 14, 2020 (FR) 2004766
Sep. 29, 2020 (FR) 2009923

(51) Int. Cl. A23D 7/005; A23D 7/04; A23L 29/256; A23L 29/244

(52) U.S. Cl. CPC A23D 7/0053; A23D 7/04; A23L 29/256; A23L 29/244

(57) ABSTRACT

The present invention relates to a composition comprising water, an oil, an alginate salt and a hydrocolloid, to a method for obtaining same and to the use thereof as a substitute for animal fat.

The present invention relates to a composition comprising water, an oil, an alginate salt and a hydrocolloid, such as glucomannan, to a method for obtaining same and to the use thereof as a substitute for animal fat, and more particularly as a substitute for animal fatty tissue.

Meat and its animal fat are frequently used in cooking. For example, bacon is a common product in Anglo-Saxon cuisine: eaten for breakfast with eggs or in a hamburger. Similarly, lard and lardoons are frequently used in French cuisine, be it in a daube, a tartiflette, a salad or a quiche lorraine.

However, following scandals in the agri-food industry, a yearning for healthier foods, and environmental considerations (animal breeding and slaughter conditions, energy consumption, etc.), some people have decided to exclude meat from their diets and are embracing various food movements such as vegetarianism, flexitarianism or veganism.

Consequently, these types of food and recipes cannot be consumed by a whole segment of the population that does not eat pork or animals in general.

While many protein-based meat substitutes have been introduced in recent years, there is still a high demand for an animal fat substitute that can be cooked and can replace the fatty part of a meat.

The work by the inventors has shown that it is possible to develop an animal fat substitute that can be cooked, specifically fried or baked, and that can be cohesively joined to a meat protein substitute in order to reproduce a meat with fat, such as lard or bacon.

The invention thus relates to a composition comprising:
55 to 70% of water,
25 to 35% of oil,
0.3 to 1.75%, preferably 0.3 to 1%, of an alginate salt,
0.5 to 8% of a hydrocolloid,

the percentages being expressed by mass relative to the total mass of the composition.

It should be noted that for the purposes of this application, and unless otherwise stipulated, the ranges of values indicated are understood to include the endpoints.

The invention thus relates to a composition, specifically a food composition, usable as a fat substitute, specifically as an animal fat substitute and such as an animal fatty tissue substitute, for example a pork fat substitute. Consequently, the composition according to the invention is more particularly suitable for non-pork eaters, vegetarians and vegans.

The composition comprises water. The water may be any food grade water, such as tap water, for example.

Preferably, the composition comprises 58 to 70% by mass, more preferably 60 to 70% by mass of water relative to the total mass of the composition.

The composition comprises oil, preferably an edible oil, more preferably a vegetable oil.

The vegetable oil is advantageously an oil with a content of at least 22% by mass of unsaturated fatty acids, the mass percentage being given on the total mass of oil. The vegetable oil is advantageously selected from sunflower oil, rapeseed oil, peanut oil, soybean oil, linseed oil, corn oil, sesame oil, pumpkin seed oil, grape seed oil, avocado oil, olive oil, nut oil (walnut, pecan, hazelnut, almond) or mixtures thereof. Preferably the vegetable oil is sunflower oil and/or rapeseed oil.

Advantageously, the composition comprises from 27 to 33% by mass of oil relative to the total mass of the composition.

The water and oil in the composition are in the form of an emulsion, such as an oil-in-water emulsion.

Advantageously, the composition comprises at least 85%, preferably at least 88%, more preferably at least 89% by mass of water and oil relative to the total mass of the composition.

“Hydrocolloid” means a water-soluble macromolecule which, in aqueous solution, produces a gel. More particularly, hydrocolloids are gum arabic, locust bean gum, xanthan gum, pectin, guar gum, kappa carrageenan, iota carrageenan, alginate salt, gellan gum, agar, glucomannan, a mixture of xanthan gum with locust bean gum, guar gum, agar, and/or gum arabic.

Advantageously, the composition according to the invention does not comprise cellulose ether.

Preferably, the composition comprises between 0.7 and 7% by mass of hydrocolloid relative to the total mass of the composition.

The composition also comprises an alginate salt. Alginate is a polysaccharide derived from brown algae. A monovalent alginate salt is capable of cross-linking in the presence of a divalent salt to form a thermally stable divalent alginate salt gel. Consequently, the alginate salt may be a monovalent salt or a divalent salt. Examples of monovalent alginate salt include sodium and/or potassium alginate. Examples of a divalent alginate salt include calcium and/or magnesium alginate.

Preferably, the composition comprises between 0.40 and 0.90% by mass of an alginate salt, more preferably between 0.45 and 0.85% by mass of an alginate salt relative to the total mass of the composition.

As indicated above, the composition according to the invention may be in liquid form or in gel form depending on the nature of the alginate salt. When the alginate salt is a monovalent salt alginate, the composition is in liquid form, the alginate salt being water soluble. When the alginate salt is a divalent alginate salt, the composition is in gel form, the alginate salt not being water soluble.

Preferably, the monovalent alginate salt is a sodium alginate, such as a highly viscous sodium alginate, and the divalent alginate salt is calcium alginate.

The invention thus also refers to a composition in liquid form and a composition in gel form.

The invention relates firstly to a composition in liquid form, which comprises:
55 to 70% of water,
25 to 35% of oil,
0.5 to 8% of a hydrocolloid,
0.3 to 1.75%, preferably 0.3 to 1% of an alginate monovalent salt,
0.03 to 0.35%, preferably 0.03 to 0.2% of calcium and/or magnesium ions,

the percentages being expressed by mass relative to the total mass of the composition.

The composition is in liquid form, specifically when it has just been prepared. Consequently, the composition is prepared from:
55 to 70% of water,
25 to 35% of oil,
0.5 to 8% of a hydrocolloid,
0.3 to 1.75%, preferably 0.3 to 1% of an alginate monovalent salt,
0.03 to 0.35%, preferably 0.03 to 0.2% of calcium and/or magnesium ions,

the percentages being expressed by mass relative to the total mass of the composition.

In particular, in the composition according to the invention, when the content of alginate monovalent salt is between 0.3 and 1% by mass, the content of calcium and/or magnesium ions is between 0.03 and 0.2% by mass, the percentages being expressed by mass relative to the total mass of the composition.

Advantageously, the molar ratio of alginate monovalent salt to calcium and/or magnesium ions is between 5 and 20, preferably the ratio is between 9 and 15.

Preferably, the divalent ions are calcium ions.

More particularly, the calcium ions are in the form of a neutral pH non-soluble salt.

Preferably, the neutral pH non-soluble salt is calcium carbonate. Indeed, when the ions used are in the form of calcium carbonate, it is possible to use a pH regulator allowing the liquid composition to become progressively more acidic over time, allowing a controlled release of calcium ions into the liquid composition according to the invention so as to control the setting time of the gel.

The composition according to the invention therefore advantageously comprises a pH regulator. The pH regulator thus allows a controlled release over time of divalent ions, for example divalent ions in the form of carbonate, such as calcium and/or magnesium carbonate.

Examples of pH regulators include glucono-delta-lactone, calcium citrate, a food ferment or encapsulated citric acid.

Advantageously, when glucono-delta-lactone is used, the ratio of calcium carbonate to glucono-delta-lactone is between 1:1 and 1:4, preferably 1:3.

In this case, the glucono-delta-lactone makes it possible to lower the pH of the liquid composition, which is usually between 6.5 and 7.5, by one to three points within 30 minutes to 1 hour, and thus to allow the composition to be gelled in a controlled manner. Specifically, this makes it possible to mould the composition in liquid form (or liquid composition) and to obtain, after gelling, a composition in gel form with a given shape.

Advantageously, the food ferment comprises lactic acid bacteria, possibly in combination with staphylococci. The lactic acid bacteria may be selected from the group consisting of lactic acid bacteria of the genus Lactobacillus, Pediococcus, Lactococcus, Streptococcus, Tetragenococcus, Leuconostoc, Oenococcus and/or Bifidobacterium. Preferably, the lactic acid bacteria are more particularly of the genus Lactobacillus, such as Lactobacillus sakei, for example. The staphylococci (genus Staphylococcus) are more particularly Staphylococcus carnosus or Staphylococcus xylosus. Preferably, the food ferment is added to the composition according to the invention at a concentration ranging between 0.7*10⁸ cfu/g and 5*10⁸ cfu/g, more preferably between 2*10⁸ cfu/g and 3*10⁸ cfu/g.

When a food ferment is used as a pH regulator, it requires adding a sugar to the composition according to the invention. Such a sugar, such as dextrose for example, is then added at a content ranging between 0.5% and 5% by mass, preferably between 0.6% and 2% by mass, of the total mass of the composition.

Secondly, the invention refers to a composition, in gel form, comprising:
55 to 70% of water,
25 to 35% of oil,
0.5 to 8% of a hydrocolloid,
0.3 to 1.75%, preferably 0.3 to 1%, of calcium and/or magnesium alginate,

the percentages being expressed by mass relative to the total mass of the composition.

The composition in gel form according to the invention is a gelled mass, i.e. the gelling is homogeneous in the mass of the composition and not only on the surface thereof.

The composition in gel form may take various forms. Indeed, as the liquid composition according to the invention can be moulded and the gelling takes place in a controlled manner over time and in the mass, this makes it possible specifically to bring the liquid composition according to the invention into contact with another edible ingredient and to cause gelling upon contact with this other ingredient, thus allowing the gel and this ingredient to adhere.

Specifically, it is possible to interpose the liquid composition between two layers of proteinaceous material and, once gelling takes place, to obtain a food comprising several layers (namely at least one layer of a composition according to the invention and one layer of proteinaceous material) which are integral (or cohesive) with each other. It should be noted in this respect that the compositions according to the invention preferably comprise less than 0.5% by mass of protein, the mass percentage being expressed relative to the total mass of the composition.

More particularly, the gel form, as referred to in the invention, is that of a gel reproducing the texture of a fatty tissue. Consequently, such a gel:
has a breaking strength of between 350 g and 5000 g,
is thermostable, in particular, it does not melt when heated.

The breaking strength is preferably measured by the following method. A texture analyser (TA.XT Plus, Stable Micro System) is used for a compression measurement, using a cylindrical mobile with a diameter of 1.3 cm. The tests are performed at 20° C.

The parameters of the texture analyser are: a penetration speed of 0.5 mm/sec, a penetration depth of 8 mm, a threshold force of 5 g. The breaking force is defined as the maximum overall force recorded during this compression experiment.

According to a first embodiment, the hydrocolloid present in the compositions according to the invention is at a content of 0.7 to 5% and is selected from the group consisting of locust bean gum, xanthan gum, guar gum and glucomannan.

Once gelled, the composition according to the invention makes it possible to obtain a fat substitute with characteristics similar to those of an animal fat:
a malleable, flexible and homogeneous texture, and
a cooking behaviour characterised by the fact that the fat substitute can be cooked in the frying pan without adding fat by browning and without charring.

Preferably, the compositions according to the invention comprise between 0.7 and 3.5% by mass of a hydrocolloid relative to the total mass of the composition.

According to a second embodiment, the hydrocolloid present in the compositions according to the invention is an alginate salt at a content of 5 to 8%.

Preferably, the compositions according to the invention comprise between 6 and 8% by mass of an alginate salt relative to the total mass of the composition.

According to a preferred embodiment, the composition according to the invention comprises:
55 to 70% of water,
25 to 35% of oil,
0.3 to 1.75%, preferably 0.3 to 1%, of an alginate salt,
0.7 to 3.5% of a glucomannan,

the percentages being expressed by mass relative to the total mass of the composition.

This preferred composition according to the invention comprises a combination of water, oil, glucomannan and alginate salt.

Once gelled, the preferred composition according to the invention makes it possible to obtain a fat substitute with all of the following characteristics, similar to those of an animal fat:
whitish colour,
low syneresis (water or oil),
malleable, flexible and homogeneous texture,
good adhesion to a proteinaceous material, and
cooking behaviour characterised by the fact that the fat substitute can be cooked in the pan without adding fat by browning and reducing in size and without charring. The preferred composition according to the invention thus comprises glucomannan. Glucomannan is a polysaccharide mainly made up of glucose and mannose. It is most often isolated from the konjac root, but can also be isolated from other plants such as orchids. Preferably, the glucomannan used in the composition is konjac glucomannan, konjac gum and/or konjac flour. Preferably, the preferred composition comprises from 1.3 to 3% by mass, more preferably, from 1.7 to 2.5% by mass of glucomannan relative to the total mass of the composition.

Similarly, the invention refers to a preferred composition in liquid form and a preferred composition in gel form.

More particularly, the preferred composition in liquid form comprises:
55 to 70% of water,
25 to 35% of oil,
0.7 to 3.5% of glucomannan,
0.3 to 1.75%, preferably 0.3 to 1% of an alginate monovalent salt,
0.03 to 0.35%, preferably 0.03 to 0.2% of calcium and/or magnesium ions,

the percentages being expressed by mass relative to the total mass of the composition.

While the preferred composition in gel form comprises:
55 to 70% of water,
25 to 35% of oil,
0.7 to 3.5% of glucomannan,
0.3 to 1.75%, preferably 0.3 to 1%, of calcium and/or magnesium alginate,

the percentages being expressed by mass relative to the total mass of the composition.

The hardness of this preferred gelled (or gel-like) composition was measured. This hardness is defined as the maximum force when compressing a fresh product cylinder of 30 mm diameter and 24 mm height with a ½″ cylinder at a speed of 0.5 mm/s and a penetration of 4 mm. This hardness is between 30 and 45 g, preferably between 35 and 41 g.

Preferably, the compositions according to the invention additionally comprise starch at a content ranging from 0 to 3% by mass relative to the total mass of the composition.

The starch present in the compositions is preferably in powder form and may be in flour form or in pure form. Examples include cassava flour, rice flour, wheat starch, corn starch, potato starch, pea flour, tapioca starch, arrowroot starch or mixtures thereof. Advantageously, the starch is cassava flour, pea flour, potato starch and/or corn starch. The starch not only makes the compositions in liquid form homogeneous but also stabilises the emulsion.

Preferably, the compositions according to the invention comprise one or more sugars at a content of up to 5% by mass relative to the total mass of the composition.

More particularly, when a ferment is used in a composition according to the invention, the sugar content, advantageously dextrose, is preferably between 0.5% and 5% by mass, preferably between 0.6% and 2% by mass, relative to the total mass of the composition, as indicated above.

In contrast, when no ferment is used in a composition according to the invention, a sugar content of up to 1% by mass relative to the total mass of the composition may be introduced.

“Sugar” means all single or double oligosaccharides. The sugar is preferably in the form of a powder. Alternatively, it may be in the form of a syrup (sugar in water). In this case, the sugar content indicated above is understood to exclude the water content, said water content to be calculated with the water content of the composition. Advantageously, the sugar is chosen from sucrose, fructose, glucose, dextrose or mixtures thereof. More preferably, when no ferment is used in a composition according to the invention, the sugar is chosen from sucrose, fructose, glucose or mixtures thereof. Adding sugar allows a Maillard reaction to take place during cooking of the compositions in gel form, giving a crisp appearance without the appearance of charring.

The compositions according to the invention may also comprise other ingredients such as salt and flavourings.

Advantageously, the compositions according to the invention comprise one or more flavourings, the flavouring content being up to 0.4% by mass relative to the mass of the composition.

The flavouring present in the composition may be, but not limited to, natural flavourings, smoke flavourings and yeast extract.

Salt (sodium chloride, potassium chloride) may be present at a content of between 0 and 5%, preferably at 0.2 to 3.5% by mass relative to the mass of the composition.

The invention also discloses a premix (or prepared mix) comprising:
3.5 to 65% of a monovalent alginate salt,
29 to 96.2% of a hydrocolloid,
0.3 to 6.5% of calcium and/or magnesium ions,

the percentages being expressed by mass relative to the total mass of alginate monovalent salt, hydrocolloid and calcium and/or magnesium ions.

The premix according to the invention is a powdery mixture. When added to water and oil, it allows the compositions to be prepared according to the invention.

The premix may also comprise starch, sugar in powder form and/or any other dry ingredient (e.g. flavouring in powder form) mentioned as suitable for adding to the above compositions.

Advantageously, the alginate monovalent salt, hydrocolloid, calcium and/or magnesium ions, starch, sugar and dry ingredients have the preferred characteristics and embodiments indicated above.

Preferably, in the premix, the hydrocolloid is glucomannan and the preferred premix according to the invention comprises:
7.2 to 55% of a monovalent alginate salt,
35 to 92% of glucomannan,
0.7 to 5.5% of calcium and/or magnesium ions,

the percentages being expressed by mass relative to the total mass of alginate monovalent salt, glucomannan and calcium and/or magnesium ions.

Advantageously, the premix is in the form of a kit. Such a kit comprises two elements: the premix according to the invention and the pH regulator, as detailed above. The kit may also contain an explanatory leaflet describing the method for preparing the composition according to the invention using the premix.

The invention also relates to a method for preparing a composition according to the invention including the following steps:

a) Preparing a dry mixture by mixing the hydrocolloid, the alginate monovalent salt, and optionally calcium and/or magnesium ions, sugar and/or starch,

b) Adding the dry mixture to oil, optionally in the presence of water, and then

c) Mixing in the presence of water to form the composition.

All the dry ingredients (hydrocolloid, alginate monovalent salt, optionally calcium and/or magnesium ions, sugar, starch, flavouring, etc.) are mixed by stirring to form the dry mixture. Alternatively, the salt and flavourings may be added after step c) and not in step a).

Preferably, a high shear mixer, such as an immersion blender, is used in step c) of mixing until a uniform mixture is obtained to form the composition.

When the ions added to the composition are calcium ions in the form of calcium carbonate, a pH regulator is added, such as glucono-delta-lactone or a ferment, to gradually acidify the composition. Preferably, the pH regulator is added to the composition after step c).

The composition is then moulded.

Advantageously, the alginate monovalent salt, hydrocolloid, calcium and/or magnesium ions, starch, sugar and dry ingredients have the preferred characteristics and embodiments indicated above.

Preferably, in the preparation method according to the invention, the hydrocolloid is glucomannan.

According to a first embodiment, the method for preparing a composition according to the invention includes the following steps:

i) Preparing an emulsion by mixing water and oil,

ii) Preparing a dry mixture by mixing the hydrocolloid, the alginate monovalent salt, and optionally calcium and/or magnesium ions, sugar and/or starch,

iii) Mixing the emulsion with the dry mixture to form the composition.

Step ii) then corresponds to step a) above, and step iii) to steps b) and c).

Water and oil are mixed to prepare an emulsion. Such an emulsion, oil in water, can be obtained using a blender, for example an immersion blender. The appearance of the emulsion is that of milk.

Preferably, the dry mixture is added to the emulsion, and together they are mixed, for example with a high shear mixer such as an immersion blender, until they become uniform to form the composition.

A method according to this first embodiment is for example implemented in Example 1.

According to a second embodiment, the method for preparing a composition according to the invention includes the following steps:

a) Preparing a dry mixture by mixing the hydrocolloid, the alginate monovalent salt, and optionally calcium and/or magnesium ions, sugar and/or starch,

b) Adding the dry mixture to a container comprising oil and water,

c) Mixing the water, oil and dry mix to form the composition.

The water and oil are poured into the same container.

Preferably, the dry ingredients are added during the oil phase. Indeed, the oil phase settles and ends up on the surface because it is less dense than the water.

Preferably they are mixed, for example with a high shear mixer such as an immersion blender, to mix the dry ingredients and split the oil in the water to obtain a whitish looking emulsion. The emulsion thickens very quickly and a uniform composition is obtained.

Implementing the method according to this second embodiment is advantageously faster than implementing the method according to the first embodiment.

According to a third embodiment, the method for preparing a composition according to the invention includes the following steps:

a) Preparing a dry mixture by mixing the hydrocolloid, the alginate monovalent salt, and optionally calcium and/or magnesium ions, sugar and/or starch,

b) Adding the dry mixture to oil and then dispersing the dry mixture in the oil,

c) Adding water to the dispersion and mixing to form the composition.

The dry ingredients are added to the oil and dispersed, for example, with a whisk, fork or spoon, preferably with a shear mixer, to obtain a turbid and aggregate-free mixture.

Water is added to the previous mixture and together they are mixed preferably with a high shear mixer, for example an immersion blender, to mix the dry ingredients and split the oil in the water to obtain a whitish looking emulsion. The emulsion thickens very quickly and a uniform composition is obtained.

The method for preparing a composition according to the invention, further includes a step d) (or iv)) of gelling.

Gelling is carried out for 45 min to 2 h, preferably about 1 hour.

The preparation method does not require heating and can be carried out at room temperature. Gelling can be carried out at room temperature (16-25° C., CNTP) or in a cool place (about 2-6° C., CNTP).

In the methods according to the invention, the compositions and their ingredients, and more particularly the alginate monovalent salt, hydrocolloid, calcium and/or magnesium ions, starch, sugar and dry ingredients advantageously have the preferred characteristics and embodiments indicated above.

Lastly, the invention relates to uses of the compositions according to the invention.

More particularly, the invention refers to the use of a composition according to the invention as a fat substitute, specifically as a substitute for animal fat tissue, such as a substitute for pork fat tissue.

The compositions, and more particularly the alginate monovalent salt, hydrocolloid, calcium and/or magnesium ions, starch, sugar and dry ingredients have the preferred characteristics and embodiments indicated above. Preferably, the hydrocolloid is glucomannan as described above.

The fat substitute has the appearance and texture of animal fat while not containing products of animal origin. Consequently, the compositions according to the invention can be used as a pork fat substitute and are suitable for non-pork eaters, as well as vegetarians and vegans.

The fat substitute can be used in a wide variety of food products, including, but not limited to, baked, grilled, pan-fried, microwaved and fried products.

Advantageously, the fat substitute is incorporated into a preparation for frying, such as lard, lardoons, brisket, bacon, coppa.

The invention also refers to a lard substitute comprising at least one layer of a composition according to the invention and at least one layer of a proteinaceous composition.

“Proteinaceous composition” means a vegetable protein composition such as an animal meat substitute. Said proteinaceous composition comprises at least 10% by mass of vegetable protein, relative to the total mass of the proteinaceous composition.

Such a proteinaceous composition, examples of which (A, B and C) are given in example 4, may contain textured vegetable protein (soy protein), water, protein isolates (soy, pea), starch, gluten, fibre, enzymes and seasonings (flavourings, salt, pepper) and/or colourings.

A method for preparing the lard substitute includes the following steps:

i) preparing a proteinaceous composition,

ii) preparing a liquid composition according to the invention,

iii) casting a first layer of proteinaceous composition or liquid composition in a mould,

iv) casting a second layer of composition on the first layer produced in step iii), the second layer of composition being a layer of proteinaceous composition if the first layer is a layer of liquid composition or alternatively the second layer of composition being a layer of liquid composition if the first layer is a layer of proteinaceous composition, steps iii) and iv) being repeatable several times

v) resting the mould thus filled for at least 6 hours.

The resting is preferably carried out at room temperature for at least 5 hours, preferably at least 10 hours.

Once the lard substitute has solidified, the different layers adhere to each other in a cohesive structure, so that the lard substitute can be handled as well as sliced, cut into lardoons, matches, etc. Similarly, it can be pan-fried without the need to add material and without charring.

In the lard substitute, the compositions, the preparation of the liquid composition and, more particularly, the alginate monovalent salt, the hydrocolloid, the calcium and/or magnesium ions, the starch, the sugar and the dry ingredients advantageously have the characteristics and preferred embodiments indicated above. Preferably, the hydrocolloid is glucomannan as described above.

The present invention is illustrated, in a non-limiting manner, by the following examples and the following FIGURE:

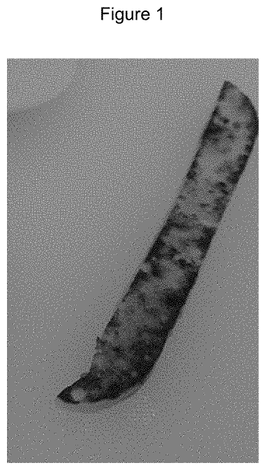

FIG. 1 is a post-cooking photograph of a composition according to the invention.

### EXAMPLE 1: PREPARING A COMPOSITION ACCORDING TO THE INVENTION

The following ingredients and quantities were used:
206 grams of tap water,
94.91 grams of sunflower oil (Avril),
6.6 grams of konjac glucomannan (Bulk Powders),
6.19 grams of cassava flour (Celnat),
2.06 grams of sodium alginate HV (E401) (Louis François),
2.06 grams of sucrose,
0.45 grams of calcium carbonate (mineraria Sacilese, Calcitec Puro PH V/40S),
1.44 grams of glucono-delta-lactone (Natural Spices, CDL).

Water and oil are mixed with an immersion blender, e.g. with a Bamix® emulsifying head, until a white emulsion (milk) is obtained. Dry ingredients excluding the GDL (konjac glucomannan, cassava flour, sodium alginate, sucrose and calcium carbonate) are mixed by stirring and then added to the emulsion and they are all mixed until they become uniform using a blender, such as a Krups® immersion blender. The GDL is then added and mixed.

Alternatively, water and oil are poured into a container. The oil migrates to the interface as its density is lower than that of the water. Dry ingredients excluding the GDL (konjac glucomannan, cassava flour, sodium alginate, sucrose and calcium carbonate) are poured into the container. They are all mixed until they become uniform using a blender, such as a Krups® immersion blender. The GDL is then added and mixed.

Implementing this alternative method is advantageously faster.

The mixture (obtained by either of the above methods) is poured into a mould and the mixture is allowed to rest in the mould for about 1 hour for gelling at room temperature or in a cool place (4° C.).

### EXAMPLE 2: COMPARATIVE TESTS OF GELLING AGENT COMBINATIONS

Comparative tests were conducted to demonstrate the synergy of combining alginate and glucomannan.

For this, alginate was combined with other hydrocolloids. The following compositions are prepared according to the ingredients and quantities given below and according to the procedure indicated in Example 1:
100 grams of water,
50 grams of sunflower oil,
3 grams of cassava flour,
1 gram of sodium alginate,
1 gram of hydrocolloid; the hydrocolloids tested being gum arabic, locust bean gum, xanthan, pectin, guar gum, kappa carrageenan, alginate, gellan gum, agar and konjac.
1 gram of sucrose,
0.25 grams of calcium carbonate,
0.75 grams of glucono-delta-lactone.

The analyses focused on the colour of the fresh product (i.e. the gelled composition but before any cooking), the syneresis of the fresh product, the texture of the fresh product and the behaviour of the product during cooking.

The colour of the product is assessed by visual inspection. The aim is to obtain a whitish colour, similar to that of lard fat.

The syneresis of each product is assessed in two different ways, on the one hand by visual inspection and on the other hand by quantitative measurement. This quantitative measurement is carried out by placing a paper towel folded into 4 (100×125 mm²) on the gel, said towel being pressed onto the gel with a cylindrical weight (31 g, 75 mm diameter) for 30 s. The pre- and post-mass of the towel is recorded and the difference is reported ({post-mass}−{pre-mass}). The purpose of visual inspection in assessing syneresis is to assess the loss of fluid to the naked eye, particularly loss of oil, and the appearance of such fluid loss. The aim is to have the lowest oil loss and if there is fluid loss, the aim is to have a minimal and uniform fluid loss and a dull appearance of the fresh product.

Texture is analysed by handling and pressing with the thumb. The two parameters studied are flexibility and malleability. Flexibility characterises the ability of the fresh product to be bent without breaking (handling) and malleability characterises the ability of the fresh product to undergo compressive stress without breaking (thumb pressure). The aim is to obtain a flexible and malleable texture.

The behaviour during cooking of the product is assessed on 2 mm thick slices of fresh product in a frying pan heated to 200-250° C. using an induction plate. The desired behaviour is that of a lard or bacon fat, specifically characterised by:
a partial release of the oil during cooking so that the fresh product can be fried without adding oil;
a reaction to cooking characterised by the fact that the fresh product browns in the pan,
cooking into the mass without burning or charring on the surface, and
a reduced size of the fresh product.

The results are presented in Table 1 below.

TABLE 1
Comparative analyses results

| | Colour of | | | Texture | |
|---|---|---|---|---|---|
| Hydrocolloids | fresh | Visual | Measurement | (relative to | Appearance |
| tested | product | syneresis | of syneresis | standard fat) | on cooking |
| Gum arabic | White | Some loss of | 0.371 g + | Malleability: ++ | Poor, no oil |
| | | fluid, oil and | droplets* | Flexibility: ++ | released |
| | | water | | | |
| Locust bean | Brownish | Surface is shiny | 0.478 g | Malleability: ++ | Decent |
| gum | white | with oil, but no | | Flexibility: ++ | quantity of |
| | | accumulation**. | | | oil released |
| Xanthan gum | Slightly | Much oil on the | 0.286 g | Malleability: ++ | Much oil |
| | translucent | surface but no | | Flexibility: + | released, |
| | brown | water lost | | | cooks well |
| Pectin | Matt white | Some oil on the | 0.233 g | Malleability: + | Little oil |
| | | surface but no | | Flexibility: ++ | released, |
| | | accumulation** | | | airing*** and |
| | | | | | charring |
| Guar gum | Translucent | Much oil lost on | 0.599 g | Malleability: ++ | Much oil |
| | brown | the fatty surface | | Flexibility: + | released, |
| | | | | | cooks well |
| Kappa | Translucent | Much oil lost on | 0.405 g | Malleability: − | Much oil |
| carrageenan | yellow | the surface | | Flexibility: + | released, |
| | | | | | cooks well. |
| | | | | | Reduces |
| | | | | | heavily. |
| Alginate | Translucent | Drains some oil | 0.353 g | Malleability: ++ | Not reactive, |
| | yellow | but no | | Flexibility: ++ | little oil |
| | | accumulation** | | | released, |
| | | | | | browns |
| Gellan gum | Pure white, | Much oil and | 0.071 g + | Malleability: − | Little oil |
| | lumpy | water lost | droplets* | Flexibility: ++ | released, |
| | | | | | browns |
| Agar gum | Translucent | Much oil and | 1.291 g + | Malleability: − | Cooks well, |
| | yellow | water lost | droplets* | Flexibility: − | some oil |
| | | | | | released |
| Konjac | Whitish | Some oil lost | 0.217 g | Malleability: ++ | Cooks well, |
| glucomannan | | but no | | Flexibility: ++ | oil released |
| | | accumulation** | | | satisfactorily |

*Droplets corresponding to the syneresis of the gel located at the bottom of the container and not captured by the towel.
**“Accumulation” means the formation of small oily cavities on the surface.
***“Airing” means that the product takes on a blown appearance, i.e. it increases in volume and loses density mainly due to formation of air cavities in the product.

It was observed that these compositions were not entirely satisfactory from the point of view of their texture and particularly with respect to criteria for syneresis or texture on fresh material.

Only by combining alginate and Konjac can the desired combination of properties be achieved. FIG. 1 is a post-cooking photograph of this alginate-konjac test.

### EXAMPLE 3: COMPARATIVE TESTS

Tests were carried out to determine the contents of each of the ingredients in the composition according to the invention. The tests were prepared in a way similar to the method described in Example 1.

The results are presented in Table 2 below.

TABLE 2
Comparative tests

| Ingredients | | | | | | |
|---|---|---|---|---|---|---|
| (percentage | Composition | Composition | Composition | Composition | Composition | Composition |
| weight) | A | B | C | D | E | F |
| Water | 64 | 64.34 | 64.26 | 62.75 | 61.15 | 64.47 |
| Oil | 30 | 30.16 | 30.12 | 29.41 | 28.66 | 29.66 |
| Alginate | 0.67 | 0.67 | 0.67 | 0.65 | 0.64 | 0.64 |
| Konjac | 2 | 2.01 | 2.01 | 1.96 | 1.91 | 2.06 |
| Cassava | 2 | 2.01 | 2.01 | 1.96 | 1.91 | 1.93 |
| flour | | | | | | |
| Sucrose | 0.67 | 0.67 | 0.67 | 0.65 | 0.64 | 0.64 |
| CaCO3 | 0.17 | 0.03 | 0.07 | 0.65 | 1.27 | 0.13 |
| Ca2+ | 0.067 | 0.012 | 0.027 | 0.255 | 0.498 | 0.051 |
| Glucono- | 0.5 | 0.1 | 0.2 | 1.96 | 3.82 | 0.45 |
| delta- | | | | | | |
| lactone | | | | | | |

The above gels are assessed on the following parameters: malleability, flexibility and homogeneity. Malleability and flexibility are as defined in example 2 above.

Homogeneity refers to a uniform structure of the gel and particularly to the absence of aggregates or lumps.

The gels obtained with compositions B, C, D and E are not very homogeneous, not very flexible and not very malleable: they therefore do not reflect the properties of the fat substitute being sought.

In contrast, compositions A and F reflect the desired characteristics in terms of malleability, flexibility and homogeneity. The percentage of calcium ions in these compositions fulfilling the desired properties is between 0.03 and 0.2%.

### EXAMPLE 4: PREPARING A LARD SUBSTITUTE ACCORDING TO THE INVENTION

Like lard, the lard substitute according to the invention comprises at least two parts, which may be alternated in succession, namely a fatty part and a lean part.

The lean part of the lard substitute can be prepared according to one of the recipes (A, B or C) whose ingredients and quantities are indicated in the tables below:

TABLE 3
Recipe A)

| Ingredients | Mass (in grams) |
|---|---|
| Textured soy protein | 15 |
| Wheat fibre | 6 |
| Wheat gluten | 4 |
| Konjac | 13 |
| Pretaline ® (tapioca-based texturising agent) | 4 |
| Pepper | 0.5 |
| Brown sugar | 4 |
| Smoked salt | 6 |
| Sunflower oil | 3 |
| Water | 250 |

In a table-top blender (Robot Coupe), blend textured soy protein, fibre, konjac, gluten, pre-taline, pepper, salt and sugar. Add the powdered fibre, then water and oil and blend instantly (otherwise some ingredients will be clumped). The mixture is then shaped by hand in a pastry frame to a thickness of about 1.5 cm. Alternatively, a rolling mill can be used.

TABLE 4
Recipe B)

| | Mass (in grams) |
|---|---|
| Broth ingredients | |
| Dry Textured Vegetable Protein (TVP) | 50 |
| Water | 1500 |
| Iron oxide | 0.15 |
| Dry ingredients | |
| Corn starch | 8.62 |
| Pea protein isolate | 12.5 |
| Methyl Cellulose | 8.62 |

The textured vegetable proteins are rehydrated in water with iron oxide boiled (˜100° C.) for 5 min. The proteins are then cooled to room temperature (˜20° C.), mixed with a flat beater (Kitchen Aid 3 L, speed 4) for 2 min, mixed manually with a spatula, and mixed again for 2 min (speed 4). The methyl cellulose is added and mixed for 2 min (Kitchen Aid 3 L, speed 4), mixed manually with a spatula to scrape the bowl, then mixed again for 1 min (speed 4). The mixture is then shaped by hand in a pastry frame to a thickness of about 1.5 cm.

Alternatively, a rolling mill can be used.

TABLE 5
Recipe C)

| Ingredients for extrusion | Portion (in grams) |
|---|---|
| Wheat gluten | 100 |
| Glycerol | 1500 |
| Tomato powder | 0.15 |

The ingredients for extrusion are mixed in a twin-screw extruder (Werner & Pfleiderer ZSK25) at a temperature of 65° C., then shaped and cut into pellets using a pelletizer (Werner & Pfleiderer ZGF). The granules are prepared by adding 3 portions of water and then shaped by hand in a mould or with a rolling mill to a layer thickness of about 1.5 cm.

The fatty part of the lard substitute is prepared as in example 1.

The lard substitute is prepared by successively pouring the fatty part onto the lean part (recipe A, B or C) in a mould, so that the fatty and lean layers alternate. The successive layers formed in the mould make up the lard substitute. To allow the fatty part to set and to facilitate the adhesion of the fatty and lean parts, the lard substitute is left to rest at a temperature of 50° C. for 1 hour, then at room temperature for 10 hours. After the lard substitute has gelled, it can be sliced, cut into matchsticks, etc., and pan-fried with or without added fat, preferably without added fat.

### EXAMPLE 5: MEASURING THE HARDNESS OF A FRESH PRODUCT ACCORDING TO THE INVENTION

The fresh product as described in example 1 is prepared and moulded into a cylinder of 30 mm diameter and 24 mm height to be tested for hardness.

Hardness is measured using a texture analyser (TA.XT Plus, Stable Micro Systems). It is defined as the maximum force when compressing a fresh product cylinder of 30 mm diameter and 24 mm height with a ½″ cylindrical tip at a speed of 0.5 mm/s and a penetration of 4 mm.

The measured hardness is 38 (+/−2) g.

### EXAMPLE 6: USING FERMENTS AS A PH REGULATOR

A ferment mix was prepared from the following ferments:

BFL-04: mixture of Lactobacillus sakei and Staphylococcus carnosus

Raw material concentration: >1.4E+10 cfu/g

Concentration in final solution [0.625%]: >8.7E+7 cfu/g

and

B-2: Lactobacillus sakei

Raw material concentration: >4.8E+10 cfu/g

Concentration in final solution [0.3125%]: >1.5E+8 cfu/g

according to the following procedure:

25 g of BFL-04 and 25 g of B-2 are solubilised in 0.975 L and 1.975 L of water respectively.

500 mL of each solution is taken and added with 1 L of water, to obtain a final stock solution (2 L in total).

For 500 g of final product, 60 mL of bacterial solution will be added at the end of mixing the powders in oil and water just before incubation.

The following composition was prepared according to the ingredients and quantities given below and according to the procedure indicated in Example 1:

TABLE 6
Composition

| | Content | |
|---|---|---|
| | (mass | |
| Ingredients | percentage) | Quantity (g) |
| Cassava starch (Celnat) | 2.01 | 10.07 |
| Sodium alginate | 1.01 | 5.04 |
| Dextrose | 0.65 | 3.27 |
| CaCO3 | 0.25 | 1.26 |
| Konjac glucomannan | 1.11 | 5.54 |
| Sunflower oil | 29.92 | 149.61 |
| Water | 65.04 | 325.21 |
| Total | 100 | 500.00 |

Once the mixture is poured into a mould, it is allowed to rest in the mould for about 1 hour for gelling in a cool place (4° C.).

The pH was measured at different times and gelling was monitored.

The pH was measured using a pH meter designed for solid and semi-solid products (Eutech pHSpear). The probe was rinsed with distilled water and introduced into the product. The pH reading is taken when the display stabilises.

The results are presented in Table 7 below:

TABLE 7
Results

| | | |
|---|---|---|
| Time | pH | Gelling |

| | | | |
|---|---|---|---|
| 6 | hrs | 8.78 | |
| 24 | hrs | 8.38 | Very soft |
| 48 | hrs | 7.70 | Soft |
| 6 | days | 7.03 | Solid |
| 15 | days | 6.89 | Completed |

1. A composition comprising:
55 to 70% of water,
25 to 35% of oil,
0.3 to 1.75% of an alginate salt, and
0.5 to 8% of a hydrocolloid,
the percentages being expressed by mass relative to the total mass of the composition.

2. The composition according to claim 1, in liquid form, comprising:
55 to 70% of water,
25 to 35% of oil,
0.5 to 8% of a hydrocolloid,
0.3 to 1.75% of an alginate monovalent salt, and
0.03 to 0.35% of calcium and/or magnesium ions,
the percentages being expressed by mass relative to the total mass of the composition.

3. The composition according to claim 1, in gel form, comprising:
55 to 70% of water,
25 to 35% of oil,
0.5 to 8% of a hydrocolloid, and
0.3 to 1.75% of calcium and/or magnesium alginate,
the percentages being expressed by mass relative to the total mass of the composition.

4. The composition according to claim 1, wherein the hydrocolloid is at a content of 0.7 to 5% and is selected from the group consisting of locust bean gum, xanthan gum, guar gum and glucomannan.

5. The composition according to claim 1, wherein the hydrocolloid is an alginate salt at a content of 5 to 8%.

6. The composition according to claim 4, comprising:
55 to 70% of water,
25 to 35% of oil,
0.3 to 1.75% of an alginate salt, and
0.7 to 3.5% of a glucomannan,
the percentages being expressed by mass relative to the total mass of the composition.

7. The composition according to claim 6, in liquid form, comprising:
55 to 70% of water,
25 to 35% of oil,
0.7 to 3.5% of glucomannan,
0.3 to 1.75% of an alginate monovalent salt, and
0.03 to 0.35% of calcium and/or magnesium ions,
the percentages being expressed by mass relative to the total mass of the composition.

8. The composition according to claim 6, in gel form, comprising:
55 to 70% of water,
25 to 35% of oil,
0.7 to 3.5% of glucomannan, and
0.3 to 1.75% of calcium and/or magnesium alginate,
the percentages being expressed by mass relative to the total mass of the composition.

9. The composition according to claim 1, further comprising starch at a content ranging from 0 to 3% by mass relative to the total mass of the composition.

10. The composition according to claim 1, further comprising one or more sugars at a content of up to 1% by mass relative to the total mass of the composition.

11. A premix comprising:
3.5 to 65% of a monovalent alginate salt,
29 to 96.2% of a hydrocolloid, and
0.3 to 6.5% of calcium and/or magnesium ions,
the percentages being expressed by mass relative to the total mass of alginate monovalent salt, hydrocolloid and calcium and/or magnesium ions.

12. A method for preparing a composition according to claim 1, comprising the following steps:
a) preparing a dry mixture by mixing the hydrocolloid, the alginate monovalent salt, and optionally calcium and/or magnesium ions, sugar and/or starch,
b) adding the dry mixture to oil, optionally in the presence of water, and then
c) mixing in the presence of water to form the composition.

13. The method according to claim 12, wherein the hydrocolloid is glucomannan.

14. The method according to the claim 12, further comprising a gelling step d).

15. A method for substituting fat in a food product comprising substituting the composition according to claim 1 for said fat.

16. A lard substitute comprising at least one layer of the composition according to claim 1 and at least one layer of a proteinaceous composition.
